(19) United States
(12) Patent Application Publication
(10) Pub. No.: US 2012/0143432 A1
(43) Pub. Date: Jun. 7, 2012

(54) Fault Diagnosis Logic of Fuel Filter Heater and Fault Diagnosis Method Therefor

(75) Inventors: Sangil YOON, Suwon-si (KR); Jongkil LIM, Hwaseong-si (KR); Suyoung PARK, Hwaseong-si (KR)

(73) Assignee: HYUNDAI MOTOR COMPANY, Seoul (KR)

(21) Appl. No.: 13/180,305

(22) Filed: Jul. 11, 2011

(30) Foreign Application Priority Data
Dec. 1, 2010 (KR) 10-2010-0121676

(51) Int. Cl. B60Q 9/00; G06F 19/00

(52) U.S. Cl. 701/29.2; 701/29.4; 701/34.4

(57) ABSTRACT

Fault diagnosis logic of a fuel filter heater may include a microprocessor electrically connected with the fuel filter heater, applying ground voltage to a power supply terminal of the fuel filter heater when an ignition switch turns on and a fuel filter relay turns on, measuring resistance of the fuel filter heater, and determining whether or not the fuel filter heater fails according to whether a measured resistance of the fuel filter heater is within a predetermined range or not.

### CROSS-REFERENCE TO RELATED APPLICATIONS

The present application claims priority to Korean Patent Application Number 10-2010-0121676 filed Dec. 1, 2010, the entire contents of which application is incorporated herein for all purposes by this reference.

### BACKGROUND OF THE INVENTION

1. Field of the Invention

The present invention relates to fault diagnosis logic of a fuel filter heater and a fault diagnosis method therefor. More particularly, the present invention relates to fault diagnosis logic of a fuel filter heater and a fault diagnosis method therefor capable of checking whether the fuel filter heater fails or not by a microprocessor in real time when a condition for diagnosing the fault of the fuel filter heater is satisfied.

2. Description of Related Art

In general, a fuel filter for a vehicle can prevent damage and a fault of an engine due to impurities in advance, by eliminating all sorts of impurities which are contained in fuel before the fuel for running the vehicle flows into the engine and supplying only pure fuel which doesn't contain the impurities to the engine.

Because the fuel filter achieves perfect combustion by evaporation of the only pure fuel to minimally reduce emission of exhaust gas caused by imperfect combustion, it can reduce environmental pollution due to the exhaust gas.

The fuel filter has a fuel filter heater that increases a temperature of the fuel to an optimal temperature to lower viscosity of the fuel. Since the fuel filter heater may not increase the temperature of the fuel to the optimal temperature when it has a fault, a problem in starting performance may occur when cold staring in the winter.

When the fault occurs in the fuel filter heater, whether the heater has the fault may be determined by measuring resistance of the heater through a separate connector 2 to measure the resistance of the heater in a fuel filter 1 as shown in FIG. 1. In other words, it is impossible to check in real time, since the fault of the fuel filter heater is determined through the separate connector only when it is arisen in the fuel filter.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

The present invention has been made in an effort to provide fault diagnosis logic of a fuel filter heater and a fault diagnosis method therefor capable of preventing damage of an engine due to a fault of the fuel filter heater and improving operation reliability of the engine including a fuel filter, because whether the fuel filter heater fails or not can be checked by a microprocessor in real time when a condition for diagnosing the fault of the fuel filter heater is satisfied.

In an aspect of the present invention, the fault diagnosis logic of a fuel filter heater, may include a microprocessor electrically connected with the fuel filter heater, applying ground voltage to a power supply terminal of the fuel filter heater when an ignition switch turns on and a fuel filter relay turns on, measuring resistance of the fuel filter heater, and determining whether or not the fuel filter heater fails according to whether a measured resistance of the fuel filter heater is within a predetermined range or not.

The microprocessor may determine that the fuel filter heater fails when the measured resistance of the fuel filter heater is not within the predetermined range, and the microprocessor limits output of an engine.

The microprocessor may determine that the fuel filter heater is normal when the measured resistance of the fuel filter heater is within the predetermined range, supplies battery voltage to the power supply terminal of the fuel filter heater, and heats the fuel filter heater.

The fault diagnosis logic of the fuel filter heater may further include an engine controller including the microprocessor, determining whether or not an input signal satisfies a diagnosis condition for diagnosing a fault of the fuel filter heater when the ignition switch turns on, and driving the microprocessor when the diagnosis condition is satisfied wherein the input signal includes battery voltage, water temperature, air temperature, and engine rpm.

The diagnosis condition is that the battery voltage is higher than approximately 24V, the water temperature is higher than approximately −20° C. and lower than approximately 90° C., the air temperature is higher than approximately −20° C. and lower than approximately 30° C., and the engine rpm is lower than approximately 650 rpm.

In another aspect of the present invention, the fault diagnosis method using fault diagnosis logic of a fuel filter heater, may include diagnosing whether or not an input signal satisfies a condition for diagnosing a fault of the fuel filter heater in an engine controller when an ignition turns on; measuring resistance of the fuel filter heater when the input signal satisfies the condition for diagnosing the fault of the fuel filter heater, and transmitting a measured resistance of the fuel filter heater to the engine controller; determining whether a received resistance of the fuel filter heater is within a predetermined range or not by the engine controller; and heating a fuel filter through the fuel filter heater when the resistance of the fuel filter heater is within the predetermined range, wherein the input signal includes battery voltage, water temperature, air temperature, and engine rpm.

The fault diagnosis method using fault diagnosis logic of the fuel filter heater may further include determining that the fuel filter heater fails in the engine controller, turning an engine checking lamp of a cluster on, and limiting output of an engine, when the resistance of the fuel filter heater is not within the predetermined range.

According to the exemplary embodiments of the present invention, fault diagnosis logic of a fuel filter heater and a fault diagnosis method therefor, it is possible to prevent damage of an engine due to a fault of the fuel filter heater and improve the operation reliability of an engine including a fuel filter, because whether the fuel filter heater fails or not can be checked by a microprocessor in real time when a condition for diagnosing the fault of the fuel filter heater is satisfied.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a general fuel filter heater.

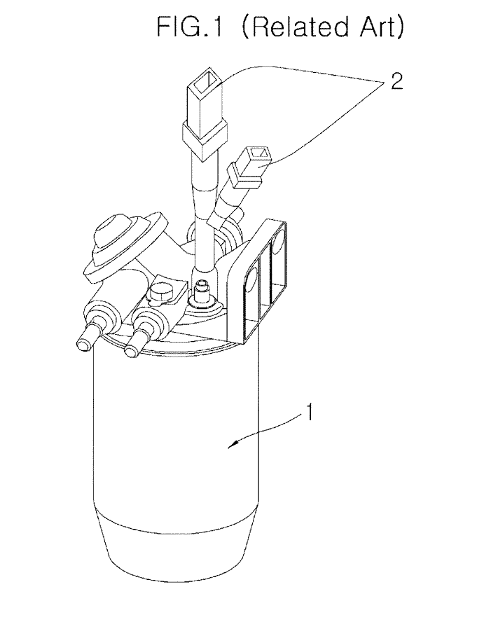

FIG. 2 is fault diagnosis logic of a fuel filter heater according to an exemplary embodiment of the present invention.

FIG. 3 is a flowchart showing a fault diagnosis method using the fault diagnosis logic of a fuel filter heater in FIG. 2.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

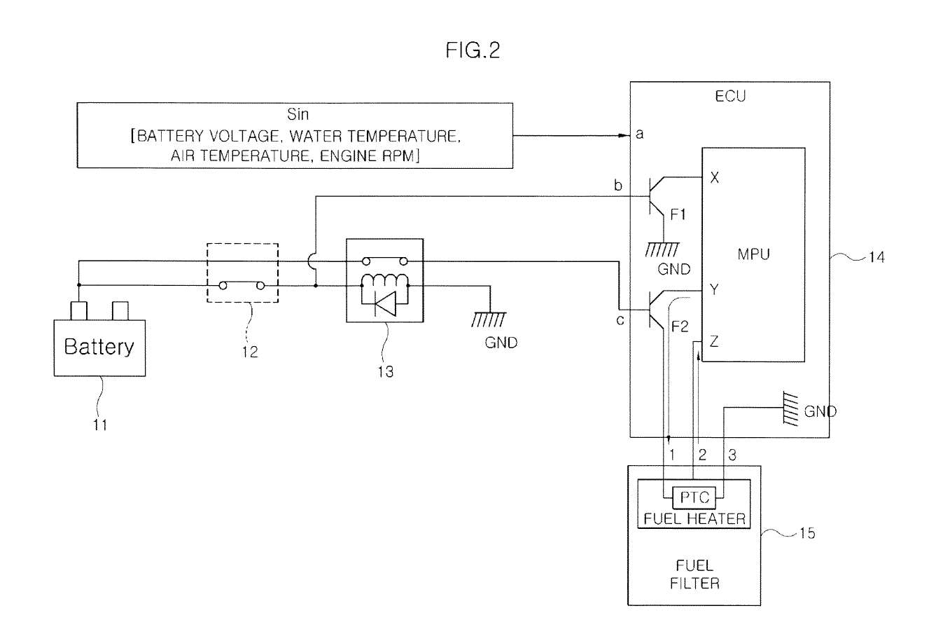

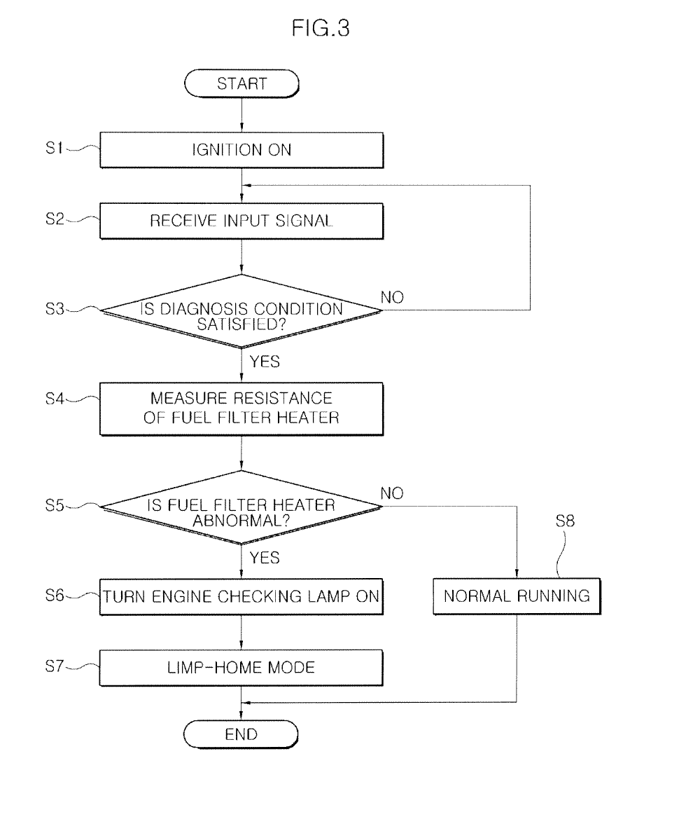

Referring to FIGS. 2 and 3, first, when an ignition switch 12 electrically connected between a battery 11 and an engine controller 14 is in an ignition on state (S1) to turn on, voltage of battery 11 is applied to an ignition on monitoring terminal b of engine controller 14.

A first transistor F1 turns on by the battery voltage applied to ignition on monitoring terminal b of engine controller (ECU) 14, and as a result, ground (GND) is connected to a first terminal X of a microprocessor (MPU) electrically connected with first transistor F1, and the microprocessor (MPU) may thus monitor that ignition switch 12 turns on.

When the voltage of battery 11 is applied to ignition on monitoring terminal b, engine controller 14 receives input signals Sin, such as battery voltage, a water temperature, an air temperature, and engine rpm through an input receiving terminal a (S2).

Engine controller 14 determines whether or not the received battery voltage, the water temperature, the air temperature, and the engine rpm that are received immediately satisfy a diagnosis condition for diagnosing a fault of a fuel filter heater (S3). Here, the diagnosis condition for diagnosing the fault of the fuel filter heater is that the battery voltage is higher than 24V, the water temperature is higher than −20° C. and lower than 90° C., the air temperature is higher than −20 ° C. and lower than 30° C., and the engine rpm is lower than 650 rpm.

When ignition switch 12 turns on, a fuel heater relay 13 turns on by the voltage of battery 11 applied through ignition switch 12, thereby transmitting the voltage of battery 11 to a fuel heater checking signal terminal c of engine controller 14.

When it is determined that the fault diagnosis condition is satisfied, the voltage of battery 11 is applied to fuel heater checking signal terminal c, a second transistor F2 of engine controller 14 turns on and voltage outputted from a second terminal Y of the microprocessor (MPU) is thus applied to a power supply terminal of fuel filter heater 15. At this time, to diagnose the fault of the fuel filter heater, the microprocessor (MPU) applies ground voltage to power supply terminal 1 of fuel filter heater 15.

A third terminal Z of the microprocessor (MPU) is electrically connected with a resistance measuring terminal 2 of fuel filter heater 15 to measure voltage between resistance measuring terminal 2 of fuel filter heater 15 and a ground terminal 3 connected with ground GND of engine controller 14 (S4). In other words, when the fault diagnosis condition of fuel filter heater 15 is satisfied, the microprocessor (MPU) applies the ground voltage to fuel filter heater 15 and then measures voltage of fuel filter heater 15.

The microprocessor (MPU) verifies whether the measured resistance of the fuel filter heater is within a normal range or not (S5). Here, the normal range may be 4.1Ω to 5.8Ω when the air temperature is 25° C. The normal range to the resistance of fuel filter heater is set by the microprocessor (MPU) according to the air temperature, and then it may determine whether fuel filter heater 15 fails or not by through comparison with this normal range.

As such, when the resistance of fuel filter heater 15 is within the normal range, the microprocessor (MPU) determines that fuel filter heater 15 is normal. Then, the microprocessor (MPU) may normally run a vehicle by supplying the battery voltage to power supply terminal 1 of fuel filter heater 15 and heating fuel filter heater 15 (S8).

Also, when the resistance of fuel filter heater 15 is not within the normal range, the microprocessor (MPU) determines that fuel filter heater 15 fails, and the microprocessor (MPU) thus warns the driver about an abnormal state of the engine by turning an engine checking lamp of a cluster on (S6). Then, engine controller 14 limits output of the engine and controls the vehicle to run in a limp-home mode (S7).

As such, the fault diagnosis logic of the fuel filter heater and the fault diagnosis method therefor can prevent damage of the engine due to the fault of the fuel filter heater, solve a consumer complaint about deterioration in cold starting performance, and improve the operation reliability of the engine including the fuel filter, because whether the fuel filter heater fails or not can be checked by the microprocessor (MPU) in real time when the condition for diagnosing the fault of the fuel filter heater is satisfied.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. Fault diagnosis logic of a fuel filter heater, comprising:
a microprocessor electrically connected with the fuel filter heater, applying ground voltage to a power supply terminal of the fuel filter heater when an ignition switch turns on and a fuel filter relay turns on, measuring resistance of the fuel filter heater, and determining whether or not the fuel filter heater fails according to whether a measured resistance of the fuel filter heater is within a predetermined range or not.

2. The fault diagnosis logic of the fuel filter heater as defined in claim 1,
wherein the microprocessor determines that the fuel filter heater fails when the measured resistance of the fuel filter heater is not within the predetermined range, and the microprocessor limits output of an engine.

3. The fault diagnosis logic of the fuel filter heater as defined in claim 1, wherein the microprocessor determines that the fuel filter heater is normal when the measured resistance of the fuel filter heater is within the predetermined range, supplies battery voltage to the power supply terminal of the fuel filter heater, and heats the fuel filter heater.

4. The fault diagnosis logic of the fuel filter heater as defined in claim 1, further comprising:
an engine controller including the microprocessor, determining whether or not an input signal satisfies a diagnosis condition for diagnosing a fault of the fuel filter heater when the ignition switch turns on, and driving the microprocessor when the diagnosis condition is satisfied.

5. The fault diagnosis logic of the fuel filter heater as defined in claim 4, wherein the input signal includes battery voltage, water temperature, air temperature, and engine rpm.

6. The fault diagnosis logic of the fuel filter heater as defined in claim 5, wherein the diagnosis condition is that the battery voltage is higher than approximately 24V, the water temperature is higher than approximately −20° C. and lower than approximately 90° C., the air temperature is higher than approximately −20° C. and lower than approximately 30° C., and the engine rpm is lower than approximately 650 rpm.

7. A fault diagnosis method using fault diagnosis logic of a fuel filter heater, comprising:
diagnosing whether or not an input signal satisfies a condition for diagnosing a fault of the fuel filter heater in an engine controller when an ignition turns on;
measuring resistance of the fuel filter heater when the input signal satisfies the condition for diagnosing the fault of the fuel filter heater, and transmitting a measured resistance of the fuel filter heater to the engine controller;
determining whether a received resistance of the fuel filter heater is within a predetermined range or not by the engine controller; and
heating a fuel filter through the fuel filter heater when the resistance of the fuel filter heater is within the predetermined range.

8. The fault diagnosis logic of the fuel filter heater as defined in claim 7, wherein the input signal includes battery voltage, water temperature, air temperature, and engine rpm.

9. The fault diagnosis method using fault diagnosis logic of the fuel filter heater as defined in claim 7, further comprising:
determining that the fuel filter heater fails in the engine controller, turning an engine checking lamp of a cluster on, and limiting output of an engine, when the resistance of the fuel filter heater is not within the predetermined range.

10. The fault diagnosis method using fault diagnosis logic of the fuel filter heater as defined in claim 7, wherein the diagnosis condition is that the battery voltage is higher than approximately 24V, the water temperature is higher than approximately −20° C. and lower than approximately 90° C., the air temperature is higher than approximately −20° C. and lower than approximately 30° C., and the engine rpm is lower than approximately 650 rpm.
